(19) United States
(12) Patent Application Publication
(10) Pub. No.: US 2026/0072303 A1
(43) Pub. Date: Mar. 12, 2026

(54) DISPLAY DEVICE

(71) Applicant: Japan Display Inc., Tokyo (JP)

(72) Inventors: Chikyu NAKAOKA, Tokyo (JP); Takeo KOITO, Tokyo (JP)

(21) Appl. No.: 19/325,754

(22) Filed: Sep. 11, 2025

(30) Foreign Application Priority Data
Sep. 12, 2024 (JP) 2024-158609

(51) Int. Cl. G02F 1/1335; G02B 27/01; G02F 1/13357

(52) U.S. Cl. CPC G02F 1/133536; G02B 27/0101; G02F 1/13362; G02B 2027/012

(57) ABSTRACT

A display device includes: a light source device configured to emit first emission light including first linearly polarized light and second linearly polarized light, in a first direction; a liquid crystal panel that includes a reflective polarizing plate configured to transmit the first linearly polarized light and reflect the second linearly polarized light in a second direction, and is configured to modulate the first linearly polarized light to emit the modulated light in the first direction as second emission light corresponding to a first image; and an optical element on which the reflected second linearly polarized light is incident along the second direction and that is configured to impart a phase difference to the incident light to emit the light in the second direction toward the reflective polarizing plate as third emission light. The liquid crystal panel is configured to modulate the third emission light to display a second image.

### CROSS-REFERENCE TO RELATED APPLICATION

This application claims the benefit of priority from Japanese Patent Application No. 2024-158609 filed on Sep. 12, 2024, the entire contents of which are incorporated herein by reference.

### BACKGROUND

### 1. Technical Field

What is disclosed herein relates to a display device.

### 2. Description of the Related Art

As an example of a display device, Japanese Patent Application Laid-open Publication No. 2006-259043 (JP-A-2006-259043) discloses an information display device including a display unit capable of displaying two pieces of information on one screen. The display device of JP-A-2006-259043 is characterized in that one piece of the information is obtained by directly viewing the display unit, and the other piece of information is obtained through a projection surface positioned above a display surface of the display unit.

In the display device of JP-A-2006-259043, the information obtained through the projection surface is visually recognized as a virtual image. The virtual image is difficult to visually recognize when surroundings are bright, for example, in the daytime.

For the foregoing reasons, there is a need for a display device capable of allowing one of two images different from each other to be visually recognized as a virtual image and improving the visibility of the virtual image.

### SUMMARY

According to an aspect, a display device includes: a light source device configured to emit first emission light in a first direction, the first emission light including first linearly polarized light and second linearly polarized light having a polarization direction orthogonal to the polarization direction of the first linearly polarized light; a liquid crystal panel including a reflective polarizing plate having a plate surface on which the first emission light is incident, the reflective polarizing plate being configured to transmit the first linearly polarized light and reflect the second linearly polarized light in a second direction different from the first direction at the plate surface, the liquid crystal panel being configured to modulate the first linearly polarized light transmitted through the reflective polarizing plate and to emit the modulated first linearly polarized light toward a light-transmitting body in the first direction as second emission light corresponding to a first image; and an optical element on which the second linearly polarized light reflected at the plate surface is incident along the second direction, the optical element being configured to impart a phase difference to the incident second linearly polarized light and to emit the second linearly polarized light in the second direction toward the plate surface as third emission light. The liquid crystal panel is configured to modulate the third emission light transmitted through the reflective polarizing plate and display a second image on a display surface. The optical element includes a quarter-wave plate on which the second linearly polarized light reflected at the plate surface is incident along the second direction, and a reflective plate configured to reflect light transmitted through the quarter-wave plate, in the second direction toward the quarter-wave plate.

### BRIEF DESCRIPTION OF THE DRAWINGS

FIG. 1 is a schematic diagram of a display device according to an embodiment of the present disclosure;

FIG. 2 is a plan view of a light source device;

FIG. 3 is a sectional view of the light source device along line III-III illustrated in FIG. 2;

FIG. 4 is a conceptual diagram of a liquid crystal panel illustrated in FIG. 1;

FIG. 5 is a plan view of the liquid crystal panel illustrated in FIG. 1;

FIG. 6 is a diagram illustrating an arrangement of first and second sub pixels illustrated in FIG. 5;

FIG. 7 is a diagram illustrating a circuit configuration of the liquid crystal panel illustrated in FIG. 5;

FIG. 8 is a sectional view of the liquid crystal panel illustrated in FIG. 5;

FIG. 9 is a plan view of a parallax barrier illustrated in FIG. 8;

FIG. 10 is a plan view of a quarter-wave plate;

FIG. 11 is a partially enlarged sectional view of a reflective plate;

FIG. 12 is a diagram illustrating luminance distribution of second emission light and third emission light;

FIG. 13 is a schematic diagram of the display device according to a first modification of the embodiment of the present disclosure;

FIG. 14 is a block diagram of the display device according to a second modification of the embodiment of the present disclosure;

FIG. 15 is a diagram illustrating an arrangement of the first and second sub pixels of the liquid crystal panel included in the display device according to a third modification of the embodiment of the present disclosure; and

FIG. 16 is a plan view of the parallax barrier of the liquid crystal panel included in the display device according to the third modification of the embodiment of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

X, Y, and Z directions illustrated in the drawings correspond to the front-back, right-left, and up-down directions of a display device 1. The X, Y, and Z directions are orthogonal to each other. In the X direction, the side indicated by an arrow is the positive X side, and the opposite side is the negative X side. In the Y direction, the side indicated by an arrow is the positive Y side, and the opposite side is the negative Y side. In the Z direction, the side indicated by an arrow is the positive Z side (upper side), and the opposite side is the negative Z side (lower side). The X, Y, and Z directions are exemplary, and the present disclosure is not limited to these directions.

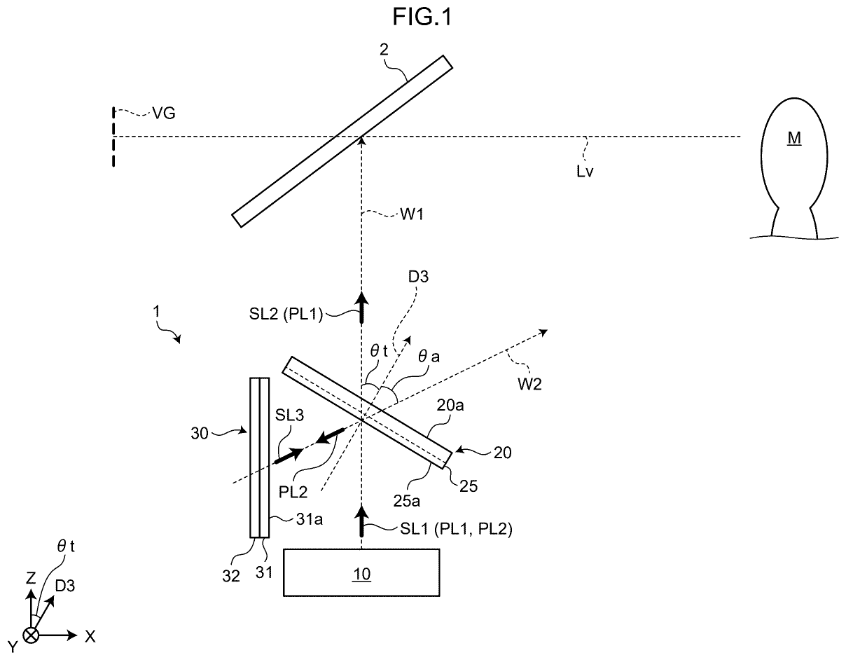

FIG. 1 is a schematic diagram of the display device 1 according to the embodiment of the present disclosure.

The display device 1 projects a first image onto a light-transmitting body 2, thereby allowing a viewer M to visually recognize a virtual image VG corresponding to the first image. The light-transmitting body 2 is plate-shaped and has a light-transmitting property. The light-transmitting body 2 is, for example, a windshield or a combiner of a vehicle but not limited to the windshield and the combiner, and may have any structure onto which an image output from the display device 1 is projected.

The display device 1 displays a second image on a display surface 20a of a liquid crystal panel 20 to be described later. The viewer M can visually recognize the second image by viewing the display surface 20a.

The display device 1 includes a light source device 10, the liquid crystal panel 20, and an optical element 30.

The light source device 10 is disposed on the negative Z side relative to the liquid crystal panel 20. The light source device 10 emits first emission light SL1. The optical axis of the first emission light SL1 extends in a first direction W1. In the present embodiment, the first direction W1 is parallel to the Z direction. The first direction W1 may be tilted relative to the Z direction. The first emission light SL1 includes first linearly polarized light PL1 and second linearly polarized light PL2. A first polarization direction of the first linearly polarized light PL1 and a second polarization direction of the second linearly polarized light PL2 are orthogonal to each other.

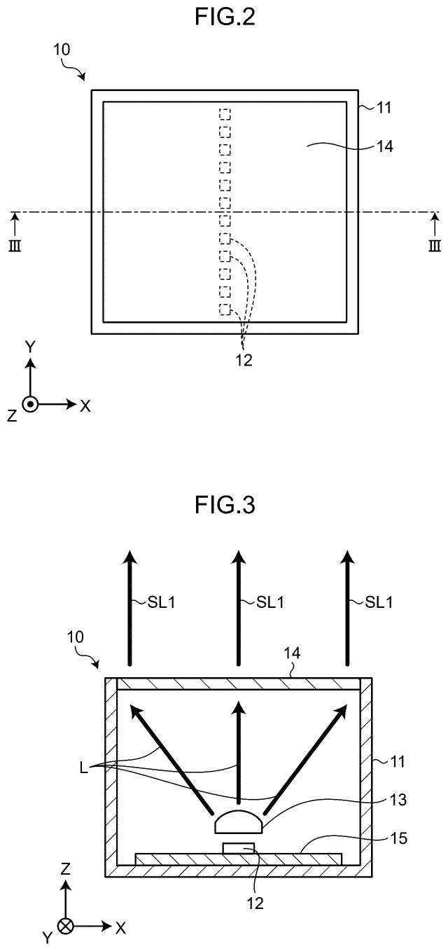

FIG. 2 is a plan view of the light source device 10. FIG. 3 is a sectional view of the light source device 10 along line III-III illustrated in FIG. 2.

The light source device 10 includes a housing 11, a plurality of light emitters 12, a first lens 13, and a plate-shaped second lens 14 (corresponding to “lens”).

The light emitters 12 are disposed on a substrate 15 positioned at a bottom of the housing 11. The light emitters 12 are arranged in a line along a direction (in the present embodiment, the Y direction) orthogonal to the first direction W1. Each light emitter 12 is, for example, a light emitting diode (LED). Each light emitter 12 emits light L toward the first lens 13.

A plurality of the first lenses 13 are housed in the housing 11. The number of the first lenses 13 is equal to the number of the light emitters 12. The first lenses 13 are disposed so as to overlap the light emitters 12 in the Z direction. The first lenses 13 are diffusion lenses. The first lenses 13 diffuse the light L emitted from the light emitters 12 in each of the X and Y directions and emit the light toward the second lens 14. Through the first lenses 13, the diffusion degree of the light L in the X direction is larger than the diffusion degree of the light L in the Y direction. This makes it possible to achieve uniformity in distribution of the light L incident on the second lens 14.

The second lens 14 refracts the light L from the first lenses 13 to collimate the light in the first direction W1 (Z direction). The second lens 14 is, for example, a Fresnel lens including a plurality of convex lenses. The collimated light from the second lens 14 corresponds to the first emission light SL1 of the light source device 10. In other words, the second lens 14 refracts the light L emitted from the light emitters 12 to align the light in the first direction W1 and emits the light as the first emission light SL1. The first emission light SL1 travels in the first direction W1.

In this manner, the light source device 10 includes the second lens 14, thereby reducing the diffusion degree of the first emission light SL1 as compared to a case where the light source device 10 does not include the second lens 14. Consequently, the luminance of the first emission light SL1 along the first direction W1 is increased. The light source device 10 does not necessarily need to include the first lenses 13.

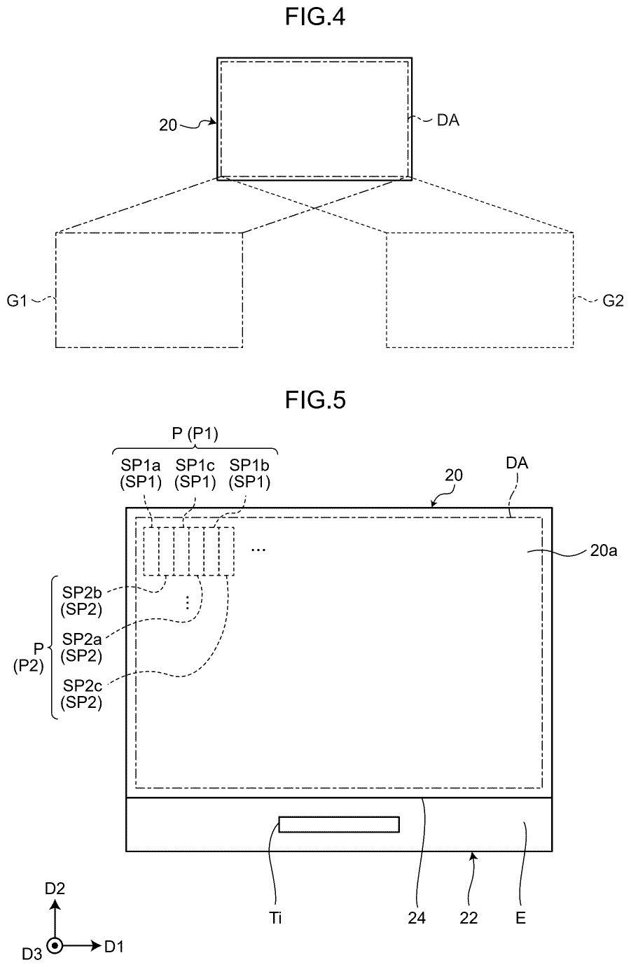

FIG. 4 is a conceptual diagram of the liquid crystal panel 20 illustrated in FIG. 1. A first image G1 and a second image G2 are simultaneously displayed in an entire display region DA of the liquid crystal panel 20 at viewing angles different from each other.

FIG. 5 is a plan view of the liquid crystal panel 20 illustrated in FIG. 1. A first panel direction D1, a second panel direction D2, and a third panel direction D3 (corresponding to “orthogonal directions”) illustrated in the drawing are orthogonal to each other. The first panel direction D1 corresponds to the width direction of the liquid crystal panel 20, the second panel direction D2 to the depth direction, and the third panel direction D3 to the vertical direction. In the first panel direction D1, the side indicated by an arrow corresponds to the positive D1 side of the liquid crystal panel 20, and the opposite side corresponds to the negative D1 side of the liquid crystal panel 20. In the second panel direction D2, the side indicated by an arrow corresponds to the positive D2 side of the liquid crystal panel 20, and the opposite side corresponds to the negative D2 side of the liquid crystal panel 20. In the third panel direction D3, the side indicated by an arrow corresponds to the positive D3 side (upper side) of the liquid crystal panel 20, and the opposite side corresponds to the negative D3 side (lower side) of the liquid crystal panel 20. The first panel direction D1, the second panel direction D2, and the third panel direction D3 are exemplary, and the present disclosure is not limited to these directions.

The liquid crystal panel 20 displays an image based on an image signal output from an external device (for example, car navigation system) that is electrically coupled to the liquid crystal panel 20 through a flexible wiring board (not illustrated).

The liquid crystal panel 20 is disposed such that the second panel direction D2 and the Y direction are parallel to each other and the third panel direction D3 and the first direction W1 are tilted relative to each other. Specifically, a tilt angle θt (refer to FIG. 1) between the third panel direction D3 and the first direction W1 is 30°±5°. When the tilt angle θt is 30°±5°, the viewer M can appropriately visually recognize the virtual image VG and the second image G2. The tilt angle θt may be larger than 35° or may be smaller than 25°.

The liquid crystal panel 20 is a transmissive liquid crystal display. The liquid crystal panel 20 may be, for example, an organic or inorganic EL display. As illustrated in FIG. 5, the liquid crystal panel 20 has the display region DA in which an image is displayed, on the display surface 20a. The display surface 20a is flat and planar. The display surface 20a is orthogonal to the third panel direction D3.

The liquid crystal panel 20 includes a plurality of pixels P disposed in a matrix of rows and columns in plan view. The row direction is parallel to the first panel direction D1. The column direction is parallel to the second panel direction D2. The pixels P overlap the display region DA in plan view of the liquid crystal panel 20. The pixels P include a plurality of first pixels P1 and a plurality of second pixels P2.

The first pixels P1 are pixels corresponding to the first image G1. Each first pixel P1 includes a first-first sub pixel SP1a, a second-first sub pixel SP1b, and a third first sub pixel SP1c. The first-first sub pixel SP1a is a red sub pixel. The second-first sub pixel SP1b is a green sub pixel. The third first sub pixel SP1c is a blue sub pixel. Hereinafter, the first-first sub pixel SP1a, the second-first sub pixel SP1b, and the third first sub pixel SP1c are simply referred to as “first sub pixels SP1” when not distinguished in description.

The second pixels P2 are pixels corresponding to the second image G2. Each second pixel P2 includes a first-second sub pixel SP2a, a second-second sub pixel SP2b, and a third second sub pixel SP2c. The first-second sub pixel SP2a is a red sub pixel. The second-second sub pixel SP2b is a green sub pixel. The third second sub pixel SP2c is a blue sub pixel. Hereinafter, the first-second sub pixel SP2a, the second-second sub pixel SP2b, and the third second sub pixel SP2c are simply referred to as “second sub pixels SP2” when not distinguished in description.

In this manner, each first pixel P1 includes the three first sub pixels SP1, and each second pixel P2 includes the three second sub pixels SP2. The number and colors of the first sub pixels SP1 and the number and colors of the second sub pixels SP2 are not limited to the above-described numbers and colors.

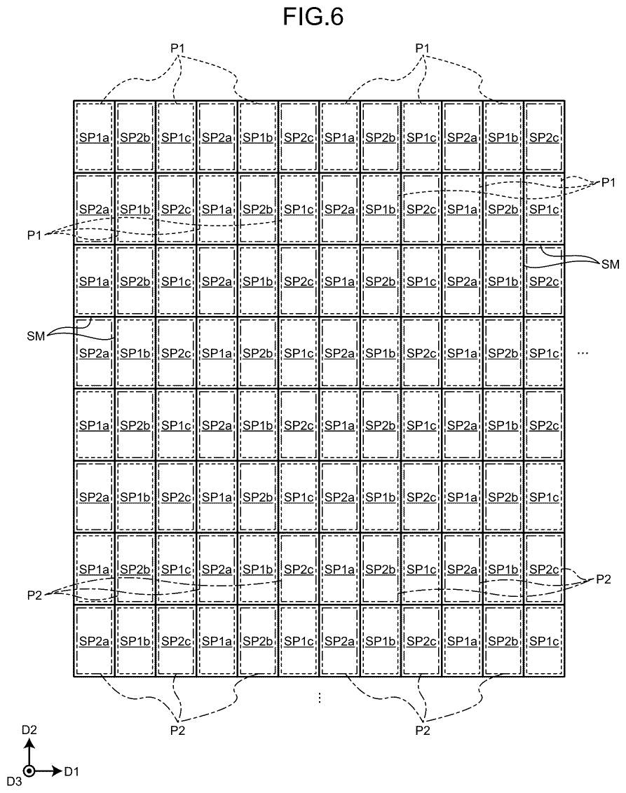

FIG. 6 is a diagram illustrating an arrangement of the first sub pixels SP1 and the second sub pixels SP2 illustrated in FIG. 5. In FIG. 6, each first sub pixel SP1 is indicated with a quadrilateral shape illustrated by dashed lines, and each second sub pixel SP2 is indicated with a quadrilateral shape illustrated by dashed and single-dotted lines.

The first pixels P1 and the second pixels P2 are each disposed in the row direction (first panel direction D1). The first pixels P1 and the second pixels P2 are each disposed in zigzag shapes in the column direction (second panel direction D2).

Focusing on the first pixels P1 arranged in the row direction, the first-first sub pixel SP1a, the third first sub pixel SP1c, and the second-first sub pixel SP1b are repeatedly disposed in the stated order in the row direction. Focusing on the second pixels P2 arranged in the row direction, the second-second sub pixel SP2b, the first-second sub pixel SP2a, and the third second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-first sub pixel SP1a is adjacent to at least one of the second-second sub pixel SP2b and the third second sub pixel SP2c in the row direction. The second-first sub pixel SP1b is adjacent to at least one of the third second sub pixel SP2c and the first-second sub pixel SP2a in the row direction. The third first sub pixel SP1c is adjacent to at least one of the first-second sub pixel SP2a and the second-second sub pixel SP2b in the row direction.

The first-second sub pixel SP2a is adjacent to at least one of the second-first sub pixel SP1b and the third first sub pixel SP1c in the row direction. The second-second sub pixel SP2b is adjacent to at least one of the third first sub pixel SP1c and the first-first sub pixel SP1a in the row direction. The third second sub pixel SP2c is adjacent to at least one of the first-first sub pixel SP1a and the second-first sub pixel SP1b in the row direction.

The first sub pixels SP1 and the second sub pixels SP2 are alternately arranged in the column direction. That is, the first sub pixels SP1 and the second sub pixels SP2 are adjacent to each other in the column direction.

Specifically, the first-first sub pixel SP1a and the first-second sub pixel SP2a are alternately arranged in the column direction. The second-first sub pixel SP1b and the second-second sub pixel SP2b are alternately arranged in the column direction. The third first sub pixel SP1c and the third second sub pixel SP2c are alternately arranged in the column direction.

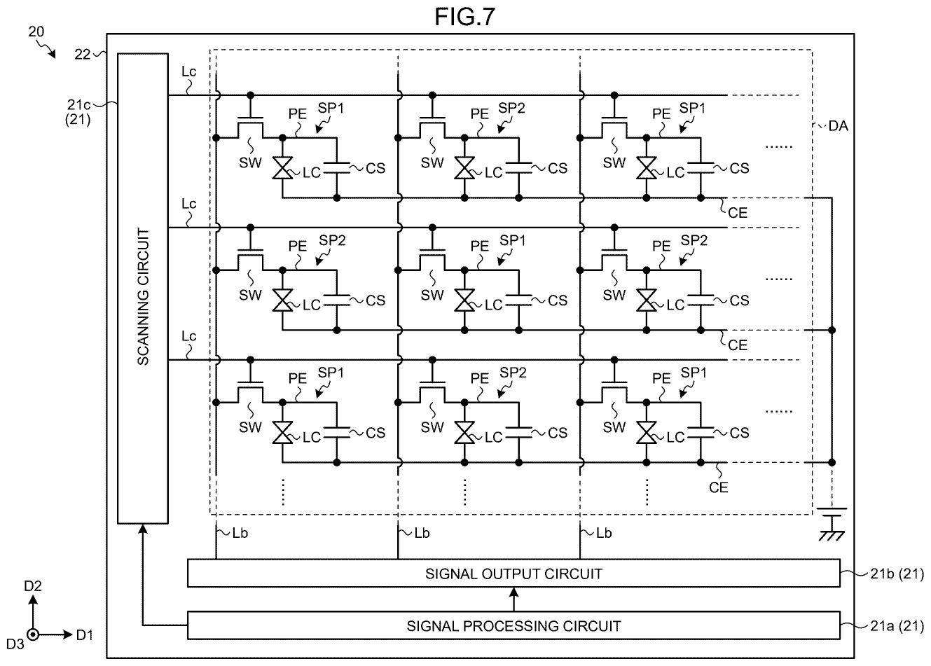

FIG. 7 is a diagram illustrating a circuit configuration of the liquid crystal panel 20 illustrated in FIG. 5. The liquid crystal panel 20 includes a drive circuit 21, and a switching element SW, a sub pixel electrode PE, a common electrode CE, a liquid crystal capacitor (capacitance) LC, and a storage capacitor CS provided in each of the first sub pixels SP1 and the second sub pixels SP2. The first sub pixels SP1 and the second sub pixels SP2 are configured in the same manner.

The drive circuit 21 drives the liquid crystal panel 20. The drive circuit 21 includes a signal processing circuit 21a, a signal output circuit 21b, and a scanning circuit 21c.

The signal processing circuit 21a outputs first sub pixel signals indicating the gradations of the first sub pixels SP1 and second sub pixel signals indicating the gradations of the second sub pixels SP2 to the signal output circuit 21b based on an image signal transmitted from an external device. The signal processing circuit 21a also outputs a clock signal synchronizing operation of the signal output circuit 21b and operation of the scanning circuit 21c to the signal output circuit 21b and the scanning circuit 21c.

The signal output circuit 21b outputs the first sub pixel signals to the first sub pixels SP1 and outputs the second sub pixel signals to the second sub pixels SP2. The signal output circuit 21b is electrically coupled to the first sub pixels SP1 and the second sub pixels SP2 through a plurality of signal lines Lb extending in the second panel direction D2.

The scanning circuit 21c scans the first sub pixels SP1 and the second sub pixels SP2 in synchronization with the outputting of the first sub pixel signals and the second sub pixel signals from the signal output circuit 21b. The scanning circuit 21c is electrically coupled to the first sub pixels SP1 and the second sub pixels SP2 through a plurality of scanning lines Lc extending in the first panel direction D1.

In a plan view of the display surface 20a, a region partitioned by two signal lines Lb adjacent to each other in the first panel direction D1 and two scanning lines Lc adjacent to each other in the second panel direction D2 corresponds to one of the first sub pixels SP1 and the second sub pixels SP2.

The switching element SW includes, for example, a thin film transistor (TFT). The switching element SW has a source electrode electrically coupled to a signal line Lb, and a gate electrode electrically coupled to a scanning line Lc.

The sub pixel electrode PE is coupled to a drain electrode of the switching element SW. A plurality of the common electrodes CE are disposed corresponding to the scanning lines Lc. The sub pixel electrode PE and the common electrode CE have a light-transmitting property.

The liquid crystal capacitor (capacitance) LC is a capacitive component of a liquid crystal material of a liquid crystal layer 23 to be described later between the sub pixel electrode PE and the common electrode CE. The storage capacitor CS is disposed between an electrode at the same potential as the common electrode CE and an electrode at the same potential as the sub pixel electrode PE.

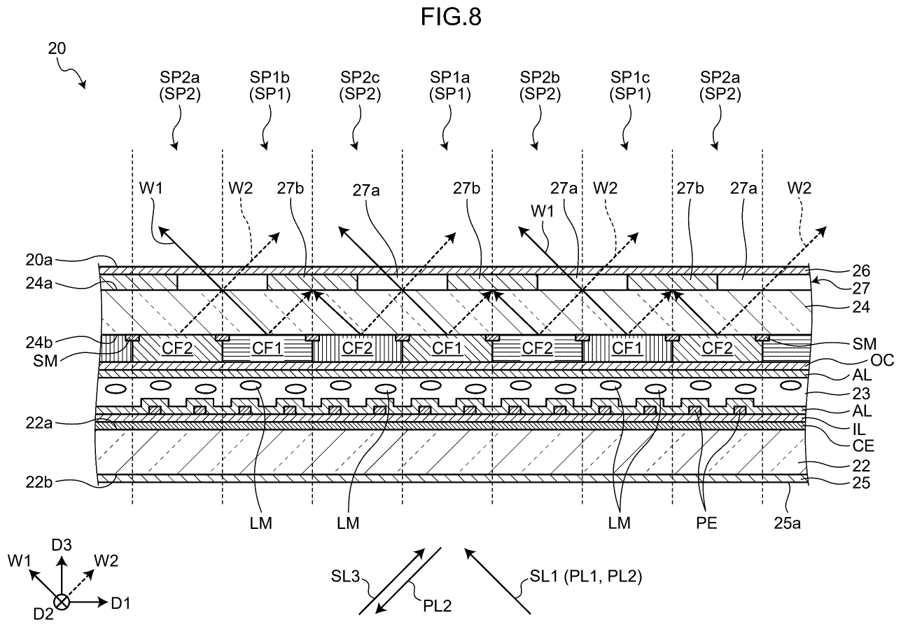

FIG. 8 is a sectional view of the liquid crystal panel 20 illustrated in FIG. 5. The liquid crystal panel 20 further includes a first substrate 22, the liquid crystal layer 23, and a second substrate 24. The first substrate 22, the liquid crystal layer 23, and the second substrate 24 have a light-transmitting property and are disposed in the stated order from the negative D3 side toward the positive D3 side in the third panel direction D3. The first substrate 22 and the second substrate 24 have quadrilateral shapes in plan view. The shapes of the first substrate 22 and the second substrate 24 in plan view may be other than quadrilateral shapes, such as circular or trapezoid shapes.

The common electrode CE is disposed on a principal surface 22a of the first substrate 22 on the positive D3 side. An insulating layer IL is disposed on the positive D3 side of the common electrode CE, and in addition, the sub pixel electrode PE and an alignment film AL are disposed thereon.

The sub pixel electrode PE is disposed between the insulating layer IL and the alignment film AL. In this manner, the common electrode CE and the sub pixel electrode PE are disposed on the first substrate 22. That is, the liquid crystal panel 20 is a liquid crystal display of a horizontal electric field type.

The second substrate 24 is positioned on the positive D3 side of the first substrate 22. An overcoat layer OC, first color filters CF1, second color filters CF2, a light-shielding film SM, and an alignment film AL are disposed on a lower surface 24b side of the second substrate 24. The light-shielding film SM, the first color filters CF1, the second color filters CF2, and the overcoat layer OC are disposed between the second substrate 24 and the alignment film AL.

The overcoat layer OC is formed of a material having a light-transmitting property.

The first color filters CF1 and the second color filters CF2 are disposed between the second substrate 24 and the liquid crystal layer 23. The first color filters CF1 are color filters included in the first sub pixels SP1. The second color filters CF2 are color filters included in the second sub pixels SP2.

The first color filters CF1 and the second color filters CF2 have quadrilateral shapes in plan view. Each of the first color filters CF1 and the second color filters CF2 has a light-transmitting property and has a predetermined peak of the spectrum of light to be transmitted. The spectrum peak corresponds to the color of a corresponding one of the first color filters CF1 and the second color filters CF2. That is, light transmitted through the first color filters CF1 and the second color filters CF2 is colored. The shapes of the first color filters CF1 and the second color filters CF2 in plan view may be changed so as to match the shapes of the first sub pixels SP1 and the second sub pixels SP2.

The colors of the first color filters CF1 are the same as the colors of the first sub pixels SP1. The colors of the second color filters CF2 are the same as the colors of the second sub pixels SP2. Specifically, each red first-first sub pixel SP1a includes a red first color filter CF1, each green second-first sub pixel SP1b includes a green first color filter CF1, and each blue third first sub pixel SP1c includes a blue first color filter CF1. Each red first-second sub pixel SP2a includes a red second color filter CF2, each green second-second sub pixel SP2b includes a green second color filter CF2, and each blue third second sub pixel SP2c includes a blue second color filter CF2.

The light-shielding film SM is light-shielding and overlaps the boundary of a first sub pixel SP1 and the boundary of a second sub pixel SP2 adjacent to each other in the first panel direction D1 and the second panel direction D2 in the plan view of the display surface 20a. In other words, the light-shielding film SM overlaps the signal lines Lb and the scanning lines Lc in the plan view of the display surface 20a. In FIG. 8, illustrations of the signal lines Lb and the scanning lines Lc are omitted. The signal lines Lb and the scanning lines Lc are disposed on the principal surface 22a of the first substrate 22. In FIG. 6, solid lines partitioning the first sub pixels SP1 and the second sub pixels SP2 correspond to the light-shielding film SM. The peripheries of the first color filters CF1 and the peripheries of the second color filters CF2 overlap the light-shielding film SM in the plan view of the display surface 20a.

As illustrated in FIG. 8, the liquid crystal layer 23 is disposed between the first substrate 22 and the second substrate 24. The liquid crystal layer 23 contains a plurality of liquid crystal molecules LM. The liquid crystal layer 23 overlaps the display region DA in the plan view of the display surface 20a. Specifically, the liquid crystal layer 23 is disposed between the two alignment films AL facing each other. The initial alignment of the liquid crystal molecules LM is determined by the two alignment films AL facing each other.

The liquid crystal panel 20 further includes a reflective polarizing plate 25, a polarizing plate 26, and a parallax barrier 27.

The reflective polarizing plate 25 is disposed on a lower surface 22b of the first substrate 22. The reflective polarizing plate 25 has a first plate surface 25a (corresponding to a “plate surface”) on which the first emission light SL1 is incident. The reflective polarizing plate 25 is configured to transmit the first linearly polarized light PL1 and reflect the second linearly polarized light PL2 in a second direction W2 different from the first direction W1 at the first plate surface 25a (refer to FIG. 1).

The first plate surface 25a is a surface of the reflective polarizing plate 25 on the negative D3 side. The first plate surface 25a corresponds to a surface of the liquid crystal panel 20 on the negative D3 side and is orthogonal to the third panel direction D3. As illustrated in FIG. 1, the first plate surface 25a faces the light source device 10. The first emission light SL1 is directly incident on the first plate surface 25a.

The reflective polarizing plate 25 has a transmission axis parallel to the first polarization direction and the third panel direction D3. Accordingly, the reflective polarizing plate 25 transmits the first linearly polarized light PL1.

Moreover, the reflective polarizing plate 25 reflects the second linearly polarized light PL2, which has a polarization direction orthogonal to that of the first linearly polarized light PL1, at the first plate surface 25a. The second linearly polarized light PL2 reflected at the first plate surface 25a travels in the second direction W2. The tilt angle θt between the third panel direction D3 and the first direction W1 and an angle θa between the third panel direction D3 and the second direction W2 are equal to each other (θt=θa).

As illustrated in FIG. 8, the polarizing plate 26 is disposed on an upper surface 24a of the second substrate 24. The polarizing plate 26 has a transmission axis orthogonal to the transmission axis of the reflective polarizing plate 25 and the third panel direction D3. A surface of the polarizing plate 26 on the positive D3 side corresponds to the display surface 20a.

The parallax barrier 27 is disposed between the second substrate 24 and the polarizing plate 26. The parallax barrier 27 is plate-shaped. The parallax barrier 27 is disposed on the surface (upper surface 24a) of the second substrate 24 on the side opposite to a surface (the lower surface 24b) facing the first color filters CF1 and the second color filters CF2. The parallax barrier 27 includes a plurality of openings 27a and a light-shielding part 27b.

The openings 27a pass light traveling in the first direction W1 among light transmitted through the first color filters CF1 of the first sub pixels SP1. The first direction W1 is indicated by solid lines in FIG. 8. The light having passed through the openings 27a and emitted from the liquid crystal panel 20 in the first direction W1 is referred to as second emission light SL2 (refer to FIG. 1; details will be described later). The openings 27a also pass light traveling in the second direction W2 among light transmitted through the second color filters CF2 of the second sub pixels SP2. The second direction W2 is indicated by dashed lines in FIG. 8.

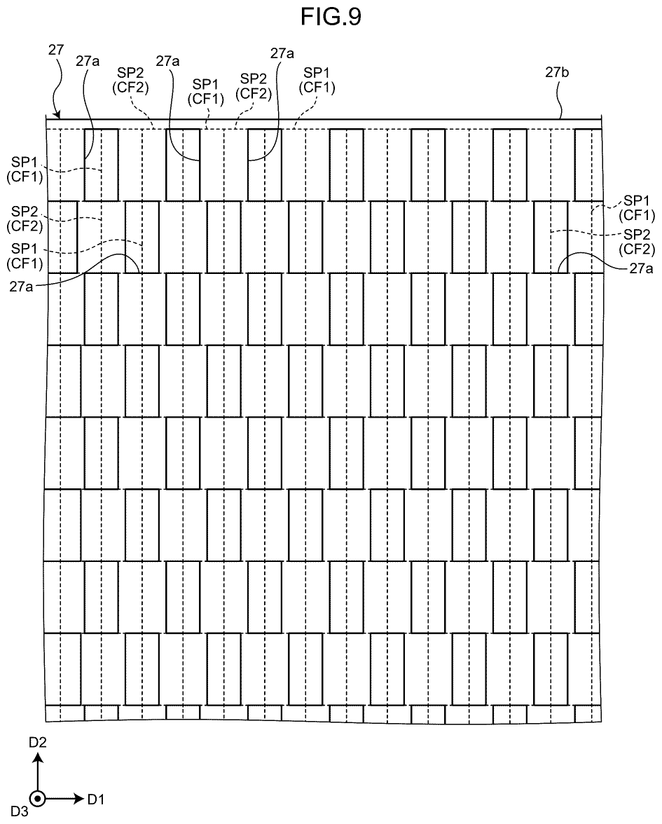

FIG. 9 is a plan view of the parallax barrier 27 illustrated in FIG. 8. In FIG. 9, the first sub pixels SP1 and the second sub pixels SP2 are illustrated with dashed lines. As illustrated in FIGS. 8 and 9, in the plan view of the display surface 20a, each opening 27a overlaps the first color filter CF1 of a first sub pixel SP1 and the second color filter CF2 of a second pixel P2 adjacent to each other in the row direction. In the plan view illustrated in FIG. 9, each opening 27a overlaps the negative D1 side of a first color filter CF1 and the positive D1 side of a second color filter CF2.

As illustrated in FIG. 9, the openings 27a are disposed in the row direction in the plan view of the display surface 20a. The openings 27a are also disposed in zigzag shapes in the column direction in plan view.

The light-shielding part 27b illustrated in FIGS. 8 and 9 is formed of a material with high light absorption (for example, metallic chromium (Cr), chromium oxide (CrO₂), or resin). The light-shielding part 27b blocks light traveling in the second direction W2 among light transmitted through the first color filters CF1 of the first sub pixels SP1. The light-shielding part 27b also blocks light traveling in the first direction W1 among light transmitted through the second color filters CF2 of the second sub pixels SP2.

As illustrated in FIG. 5, the first substrate 22 includes an exposed part E that is exposed from the second substrate 24 in plan view. The exposed part E is positioned on the negative D2 side relative to the second substrate 24 in plan view. An IC chip Ti including the drive circuit 21 is disposed on the upper surface of the exposed part E. A surface of the exposed part E on the positive D3 side is part of the principal surface 22a of the first substrate 22.

As illustrated in FIG. 1, the optical element 30 is disposed at a position where the second linearly polarized light PL2 reflected by the first plate surface 25a is incident along the second direction W2. The optical element 30 is disposed on the negative X side relative to the light source device 10. When the display device 1 is viewed in the first direction W1 (Z direction), the optical element 30 does not overlap the light source device 10 and the liquid crystal panel 20. The optical element 30 is plate-shaped and disposed such that a second plate surface 31a to be described later and the Z direction are parallel to each other.

The optical element 30 includes a quarter-wave plate 31 and a reflective plate 32.

The second linearly polarized light PL2 reflected by the first plate surface 25a of the reflective polarizing plate 25 enters the quarter-wave plate 31 in the second direction W2 from the second plate surface 31a. The second plate surface 31a corresponds to a surface of the optical element 30 on the positive X side.

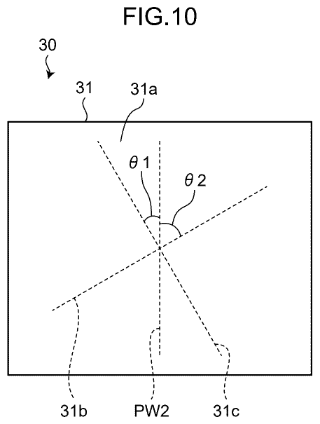

FIG. 10 is a plan view of the quarter-wave plate 31. The quarter-wave plate 31 has a fast axis 31b and a slow axis 31c. FIG. 10 illustrates a second polarization direction PW2. The fast axis 31b and the slow axis 31c are orthogonal to each other. In the plan view of the quarter-wave plate 31, a first angle θ1 between the second polarization direction PW2 of the second linearly polarized light PL2 and the fast axis 31b is different from a second angle θ2 between the second polarization direction PW2 of the second linearly polarized light PL2 and the slow axis 31c.

The second linearly polarized light PL2 incident on the quarter-wave plate 31 is imparted with a phase difference when transmitted through the quarter-wave plate 31 in the second direction W2, and is incident on the reflective plate 32. The first angle θ1 and the second angle θ2 are different from each other as described above, and the phase difference imparted to the second linearly polarized light PL2 is different from an integral multiple of a quarter wavelength.

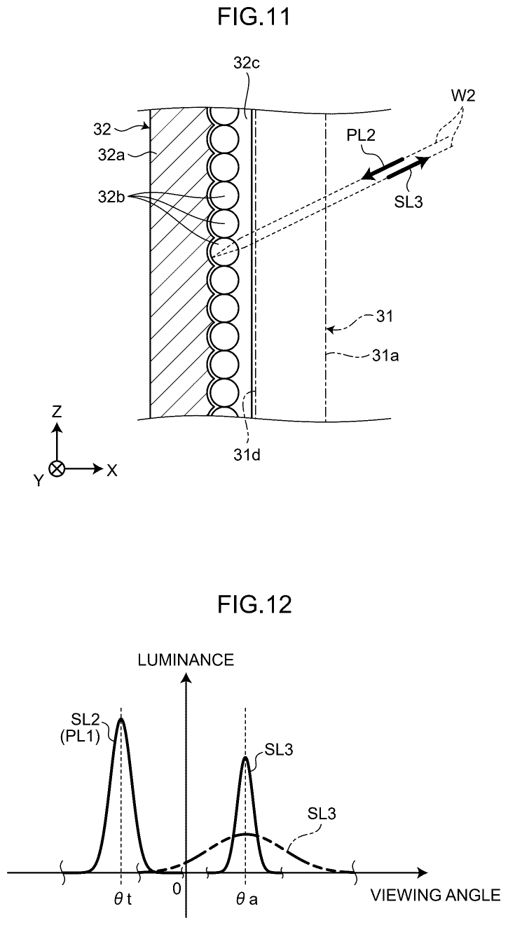

FIG. 11 is a partially enlarged sectional view of the reflective plate 32. The reflective plate 32 is disposed on an opposite surface 31d of the quarter-wave plate 31, which is opposite to the second plate surface 31a.

The reflective plate 32 is a retroreflective plate. Specifically, the reflective plate 32 reflects incident light at an emission angle equal to the incident angle of the incident light. The reflective plate 32 includes a base member 32a, a plurality of light-transmitting spheres 32b, and an adhesive layer 32c.

The base member 32a is a metal film having a relatively high reflectance, that is made of aluminum or silver, for example. The light-transmitting spheres 32b are light-transmitting spheres made of, for example, glass. The light-transmitting spheres 32b are disposed on the surface of the base member 32a. The adhesive layer 32c is formed in a layer structure made of a light-transmitting bonding agent. The light-transmitting spheres 32b are fixed to the base member 32a by the adhesive layer 32c.

Light transmitted through the quarter-wave plate 31 and incident along the second direction W2 is converged to a point at a bottom part of each light-transmitting sphere 32b by a lens effect of the light-transmitting sphere 32b and is reflected. The light reflected at the bottom part of each light-transmitting sphere 32b travels in the second direction W2 by the lens effect of the light-transmitting sphere 32b. In this manner, the reflective plate 32 reflects, in the second direction W2, light incident along the second direction W2. In other words, the reflective plate 32 reflects, in the second direction W2 toward the quarter-wave plate 31, light transmitted through the quarter-wave plate 31.

The light reflected by the reflective plate 32 is transmitted through the quarter-wave plate 31 again and further imparted with a phase difference different from an integral multiple of a quarter wavelength as described above. Accordingly, when the second linearly polarized light PL2 incident on the optical element 30 in the second direction W2 is reflected at the optical element 30, the second linearly polarized light PL2 is imparted with a phase difference different from an integral multiple of a quarter wavelength while being transmitted through the quarter-wave plate 31 twice, and is emitted in the second direction W2 from the optical element 30. Hereinafter, the light emitted from the optical element 30 is referred to as third emission light SL3.

The third emission light SL3 is polarized light having a phase difference different from an integral multiple of a quarter wavelength with respect to the second polarization direction PW2 of the second linearly polarized light PL2.

As illustrated in FIG. 1, the third emission light SL3 emitted from the optical element 30 travels in the second direction W2 toward the first plate surface 25a of the reflective polarizing plate 25. In this manner, the optical element 30 imparts a phase difference to the second linearly polarized light PL2 and emits the light in the second direction W2 toward the first plate surface 25a as the third emission light SL3.

The following describes operation of the display device 1.

As illustrated in FIG. 1, the light source device 10 emits the first emission light SL1 in the first direction W1 toward the liquid crystal panel 20. The first linearly polarized light PL1 included in the first emission light SL1 is transmitted through the reflective polarizing plate 25 and transmitted through the liquid crystal panel 20 in the first direction W1. As described above, the transmission axis of the reflective polarizing plate 25 is parallel to the first polarization direction of the first linearly polarized light PL1. Thus, the luminance of the first linearly polarized light PL1 does not decrease when the first linearly polarized light PL1 is transmitted through the reflective polarizing plate 25.

The second linearly polarized light PL2 included in the first emission light SL1 is reflected by the first plate surface 25a of the reflective polarizing plate 25 and incident on the optical element 30. As described above, the optical element 30 emits the third emission light SL3, which is obtained by imparting a phase difference to the second linearly polarized light PL2, in the second direction W2 toward the reflective polarizing plate 25.

The polarization direction of the third emission light SL3 is different from the first polarization direction and the second polarization direction PW2. Accordingly, the third emission light SL3 is transmitted through the reflective polarizing plate 25. The luminance of the third emission light SL3 decreases when the third emission light SL3 is transmitted through the reflective polarizing plate 25.

Before the first linearly polarized light PL1 and the third emission light SL3 are incident on the reflective polarizing plate 25, the luminance of the first linearly polarized light PL1 and the luminance of the third emission light SL3 are substantially equal to each other.

Accordingly, after the first linearly polarized light PL1 and the third emission light SL3 are transmitted through the reflective polarizing plate 25, the luminance of the first linearly polarized light PL1 is higher than the luminance of the third emission light SL3. The third emission light SL3 transmitted through the reflective polarizing plate 25 is transmitted through the liquid crystal panel 20 in the second direction W2.

Upon acquiring an image signal transmitted from an external device, the liquid crystal panel 20 illustrated in FIG. 8 displays the first image G1 and the second image G2 in the display region DA as described below.

The image signal includes the gradations of the first sub pixels SP1 corresponding to the first image G1 and the gradations of the second sub pixels SP2 corresponding to the second image G2. As described above, the first sub pixel signals indicating the gradations of the first sub pixels SP1 are output to the first sub pixels SP1, and the second sub pixel signals indicating the gradations of the second sub pixels SP2 are output to the second sub pixels SP2.

Voltages corresponding to the gradations indicated by the first sub pixel signals are applied to regions of the liquid crystal layer 23 corresponding to the first sub pixels SP1, and the liquid crystal molecules LM are tilted.

The degree of tilt of the liquid crystal molecules LM changes with the gradations indicated by the first sub pixel signals. The first linearly polarized light PL1 and the third emission light SL3 transmitted through the regions of the liquid crystal layer 23 corresponding to the first sub pixels SP1 are modulated to the gradations indicated by the first sub pixel signals. In addition, the first linearly polarized light PL1 and the third emission light SL3 transmitted through the regions of the liquid crystal layer 23 corresponding to the first sub pixels SP1 are colored by being transmitted through the first color filters CF1. The first linearly polarized light PL1 and the third emission light SL3 transmitted through the liquid crystal panel 20 via the first color filters CF1 correspond to the first image G1.

Among the first linearly polarized light PL1 and the third emission light SL3 transmitted through the first color filters CF1, the third emission light SL3 travels in the second direction W2 and is blocked by the light-shielding part 27b. Accordingly, the third emission light SL3 transmitted through the first color filters CF1 is not visually recognizable.

However, among the first linearly polarized light PL1 and the third emission light SL3 transmitted through the first color filters CF1, the first linearly polarized light PL1 travels in the first direction W1, passes through the openings 27a of the parallax barrier 27, and is externally emitted from the display surface 20a. The first linearly polarized light PL1 emitted from the display surface 20a corresponds to the second emission light SL2 (refer to FIG. 1).

The second emission light SL2 corresponds to the first image G1. The second emission light SL2 travels in the first direction W1 toward the light-transmitting body 2 (refer to FIG. 1). In this manner, the liquid crystal panel 20 modulates the first linearly polarized light PL1 transmitted through the reflective polarizing plate 25 and emits the modulated first linearly polarized light PL1 toward the light-transmitting body 2 in the first direction W1 as the second emission light SL2 corresponding to the first image G1.

Voltages corresponding to the gradations indicated by the second sub pixel signals are applied to regions of the liquid crystal layer 23 corresponding to the second sub pixels SP2, and the liquid crystal molecules LM are tilted. The degree of tilt of the liquid crystal molecules LM changes with the gradations indicated by the second sub pixel signals. The first linearly polarized light PL1 and the third emission light SL3 transmitted through the regions of the liquid crystal layer 23 corresponding to the second sub pixels SP2 are modulated to the gradations indicated by the second sub pixel signals. In addition, the first linearly polarized light PL1 and the third emission light SL3 transmitted through the regions of the liquid crystal layer 23 corresponding to the second sub pixels SP2 are colored by being transmitted through the second color filters CF2. The first linearly polarized light PL1 and the third emission light SL3 transmitted through the liquid crystal panel 20 via the second color filters CF2 correspond to the second image G2.

Among the first linearly polarized light PL1 and the third emission light SL3 transmitted through the second color filters CF2, the first linearly polarized light PL1 travels in the first direction W1 and is blocked by the light-shielding part 27b. Accordingly, among the first linearly polarized light PL1 and the third emission light SL3 transmitted through the second color filters CF2, the first linearly polarized light PL1 traveling in the first direction W1 is not visually recognizable.

However, among the first linearly polarized light PL1 and the third emission light SL3 transmitted through the second color filters CF2, the third emission light SL3 travels in the second direction W2, passes through the openings 27a of the parallax barrier 27, and is externally emitted from the display surface 20a. Thus, the third emission light SL3 is visually recognizable as the second image G2. Accordingly, the liquid crystal panel 20 modulates the third emission light SL3 transmitted through the reflective polarizing plate 25 and displays the second image G2 on the display surface 20a.

In this manner, the parallax barrier 27 passes the first linearly polarized light PL1 transmitted through the first sub pixels SP1, passes the third emission light SL3 transmitted through the second sub pixels SP2, and blocks the third emission light SL3 transmitted through the first sub pixels SP1 and the first linearly polarized light PL1 transmitted through the second sub pixels SP2. With the parallax barrier 27, the viewing angle of the first image G1 and the viewing angle of the second image G2 are different from each other.

The viewer M illustrated in FIG. 1 directly visually recognizes the second image G2 on the display surface 20a. However, the viewer M cannot directly visually recognize the first image G1 on the display surface 20a.

The second emission light SL2 emitted from the display surface 20a travels in the first direction W1 toward the light-transmitting body 2 and is projected onto the light-transmitting body 2. The viewer M directing a sight line Lv to the second emission light SL2 projected onto the light-transmitting body 2, visually recognizes the first image G1 as the virtual image VG.

As described above, the first linearly polarized light PL1 is included in the first emission light SL1, emitted in the first direction W1 from the light source device 10, and transmitted through the liquid crystal panel 20. Thus, the luminance of the first linearly polarized light PL1 and the second emission light SL2 can be increased. Accordingly, the visibility of the virtual image VG improves. In this manner, it is possible to improve the visibility of the virtual image VG in the display device 1 capable of allowing one of two images different from each other to be visually recognized as the virtual image VG.

Moreover, it is possible to increase the luminance of the first emission light SL1 with the second lens 14 of the light source device 10. Thus, it is possible to further increase the luminance of the first linearly polarized light PL1 included in the first emission light SL1, in other words, the second emission light SL2. Accordingly, it is possible to further improve the visibility of the virtual image VG in the display device 1.

FIG. 12 is a diagram illustrating luminance distribution of the second emission light SL2 and the third emission light SL3. The vertical axis illustrated in FIG. 12 represents the luminance. The horizontal axis illustrated in FIG. 12 represents the viewing angle in the first panel direction D1. The viewing angle of 0° means viewing the display surface 20a of the liquid crystal panel 20 in the third panel direction D3.

As described above, the luminance of the second emission light SL2 corresponds to the luminance of the first linearly polarized light PL1, and is higher than the luminance of the third emission light SL3. Accordingly, it is possible to set the luminance of the third emission light SL3 to an appropriate luminance even when the luminance of the first emission light SL1 is increased. Thus, the viewer M can visually recognize the second image G2 at an appropriate brightness. The luminance of the third emission light SL3 can be adjusted by the first angle θ1 and the second angle θ2 illustrated in FIG. 10.

As described above, the light source device 10 decreases the diffusion degree of the first emission light SL1, that is, the first linearly polarized light PL1, as compared to a case where the second lens 14 is not provided. The diffusion degree of the third emission light SL3 is substantially equal to the diffusion degree of the first linearly polarized light PL1. Thus, it is possible to ensure that the viewing angle of the first image G1 corresponding to the first linearly polarized light PL1 does not overlap the viewing angle of the second image G2 corresponding to the third emission light SL3. Accordingly, it is possible to prevent visual recognition of the first image G1 and the second image G2 in an overlapped state (what is called crosstalk) when the viewer M views the display surface 20a between the first panel direction D1 and the second panel direction D2.

Moreover, since the reflective plate 32 is a retroreflective plate, the flexibility of posture of the optical element 30 improves. In the present embodiment, since the optical element 30 is disposed such that the plate surface (second plate surface 31a) of the optical element 30 and the Z direction are parallel to each other as described above, it is possible to downsize the display device 1. The optical element 30 may be disposed such that the plate surface (second plate surface 31a) of the optical element 30 is tilted relative to the Z direction.

A preferable embodiment of the present disclosure is described above, but the present disclosure is not limited thereto. Contents disclosed in the embodiment are merely exemplary, and various kinds of modifications are possible without departing from the scope of the present disclosure. Any modification performed as appropriate without departing from the scope of the present disclosure belongs to the technical scope of the present disclosure.

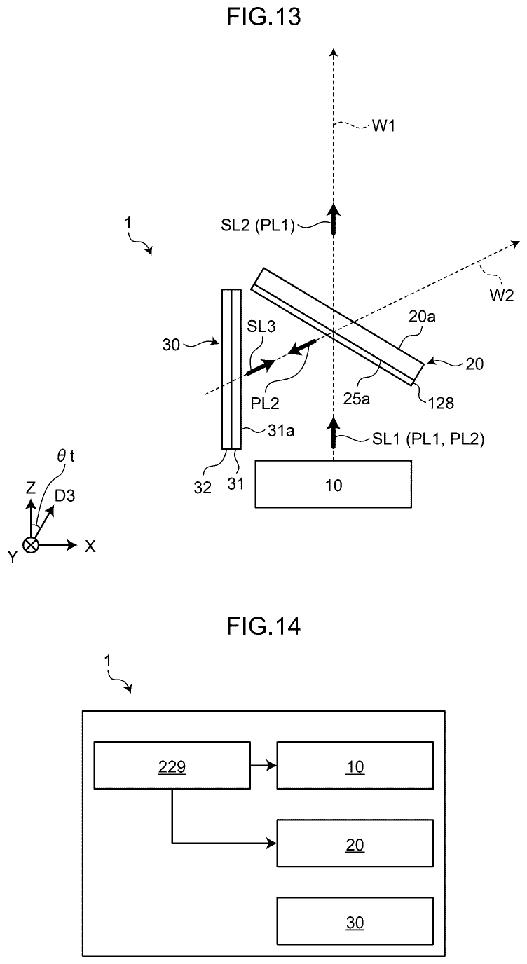

FIG. 13 is a schematic diagram of the display device 1 according to a first modification of the embodiment of the present disclosure.

The display device 1 of the first modification further includes a diffusion sheet 128 as compared to the above-described display device 1 of the embodiment. The diffusion sheet 128 is disposed between the light source device 10 and the first plate surface 25a and between the optical element 30 and the first plate surface 25a. In the present modification, the diffusion sheet 128 is disposed on the first plate surface 25a.

The first linearly polarized light PL1 included in the first emission light SL1 is transmitted through the diffusion sheet 128 and the liquid crystal panel 20, travels toward the light-transmitting body 2 as the second emission light SL2, and is visually recognized as the virtual image VG corresponding to the first image G1. Accordingly, the first linearly polarized light PL1 is transmitted through the diffusion sheet 128 once before being visually recognized as the virtual image VG.

However, the second linearly polarized light PL2 included in the first emission light SL1 is transmitted through the diffusion sheet 128 and reflected by the first plate surface 25a of the reflective polarizing plate 25. The second linearly polarized light PL2 reflected by the first plate surface 25a is transmitted through the diffusion sheet 128 again, incident on the optical element 30, and emitted from the optical element 30 as the third emission light SL3. In addition, the third emission light SL3 is transmitted through the diffusion sheet 128 and the liquid crystal panel 20 and visually recognized as the second image G2. Accordingly, the second linearly polarized light PL2 is transmitted through the diffusion sheet 128 three times before being visually recognized as the second image G2.

As a result, in the first modification, the diffusion degree of the third emission light SL3 is larger than the diffusion degree of the second emission light SL2 as illustrated with a dashed and double-dotted line in FIG. 12, and the viewing angle of the second image G2 increases. Thus, it is possible to increase the viewing angle of the second image G2 while avoid reducing what is called crosstalk.

Moreover, with the diffusion sheet 128, the luminance of the third emission light SL3, in other words, the luminance of the second image G2 can be set lower than the luminance of the first linearly polarized light PL1, in other words, the luminance of the first image G1. Thus, with the diffusion sheet 128, it is possible to adjust the luminance difference between the first image G1 and the second image G2.

FIG. 14 is a block diagram of the display device 1 according to a second modification of the embodiment of the present disclosure. In the second modification, the display device 1 further includes an illuminance sensor 229 configured to detect the degree of brightness outside the display device 1. The illuminance sensor 229 includes a phototransistor, a photodiode, and the like. The result of detection by the illuminance sensor 229 is transmitted to the light source device 10 and the liquid crystal panel 20.

The light source device 10 may set the luminance of the first emission light SL1 higher as the brightness degree detected by the illuminance sensor 229 is larger (as the outside is brighter). In other words, the light source device 10 sets the luminance of the light emitters 12 higher as the brightness degree detected by the illuminance sensor 229 is larger.

This can make the luminance of the first linearly polarized light PL1 and the second emission light SL2 high, for example, in the daytime, and accordingly, the brightness degree of the virtual image VG increases and the visibility of the virtual image VG improves.

Moreover, the drive circuit 21 of the liquid crystal panel 20 may decrease the gradations of the second sub pixels SP2 in the second sub pixel signals corresponding to the second image G2 as the brightness degree detected by the illuminance sensor 229 is larger.

Accordingly, the luminance of the third emission light SL3 transmitted through the liquid crystal panel 20 decreases and the brightness degree of the second image G2 is suppressed. Specifically, as the brightness degree detected by the illuminance sensor 229 is larger, the difference between the luminance of the second emission light SL2 and the luminance of the third emission light SL3 transmitted through the liquid crystal panel 20 increases, and the brightness degree difference between the virtual image VG and the second image G2 increases.

In this case, increase in the brightness degree of the second image G2 due to increase in the luminance of the light emitters 12 as described above is suppressed, and the viewer M can visually recognize the second image G2 at an appropriate brightness.

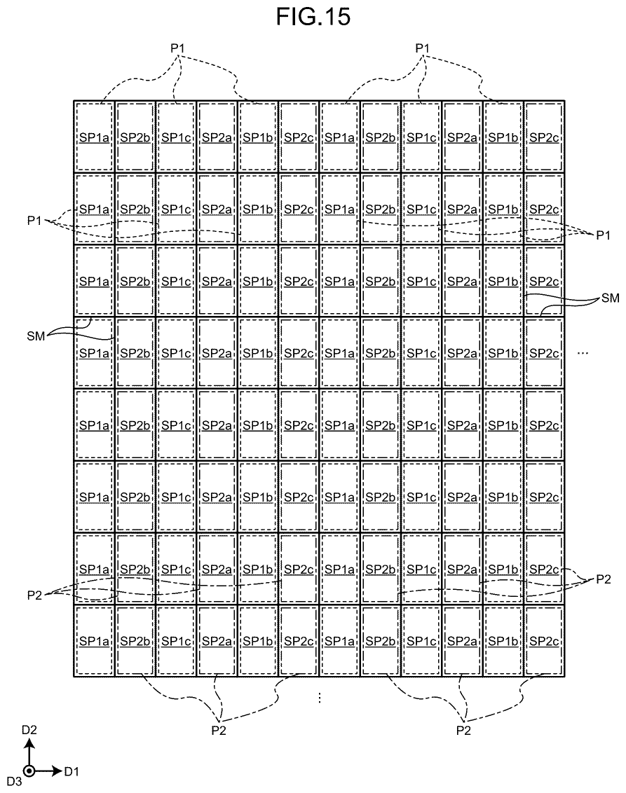

FIG. 15 is a diagram illustrating an arrangement of the first sub pixels SP1 and the second sub pixels SP2 of the liquid crystal panel 20 included in the display device 1 according to a third modification of the embodiment of the present disclosure.

In the third modification, the first pixels P1 and the second pixels P2 are each disposed in the row direction (first panel direction D1) and the column direction (second panel direction D2). Focusing on the first pixels P1 arranged in the row direction, the first-first sub pixel SP1a, the third first sub pixel SP1c, and the second-first sub pixel SP1b are repeatedly disposed in the stated order in the row direction. Focusing on the second pixels P2 arranged in the row direction, the second-second sub pixel SP2b, the first-second sub pixel SP2a, and the third second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-first sub pixel SP1a is adjacent to at least one of the second-second sub pixel SP2b and the third second sub pixel SP2c in the row direction. The second-first sub pixel SP1b is adjacent to at least one of the third second sub pixel SP2c and the first-second sub pixel SP2a in the row direction. The third first sub pixel SP1c is adjacent to at least one of the first-second sub pixel SP2a and the second-second sub pixel SP2b in the row direction.

The first-second sub pixel SP2a is adjacent to at least one of the second-first sub pixel SP1b and the third first sub pixel SP1c in the row direction. The second-second sub pixel SP2b is adjacent to at least one of the third first sub pixel SP1c and the first-first sub pixel SP1a in the row direction. The third second sub pixel SP2c is adjacent to at least one of the first-first sub pixel SP1a and the second-first sub pixel SP1b in the row direction.

The first sub pixels SP1 are disposed in the column direction. Specifically, the first-first sub pixels SP1a are disposed in a state of being adjacent to each other in the column direction. The second-first sub pixels SP1b are disposed in a state of being adjacent to each other in the column direction. The third first sub pixels SP1c are disposed in a state of being adjacent to each other in the column direction.

The second sub pixels SP2 are disposed in the column direction. Specifically, the first-second sub pixels SP2a are disposed in a state of being adjacent to each other in the column direction. The second-second sub pixels SP2b are disposed in a state of being adjacent to each other in the column direction. The third second sub pixels SP2c are disposed in a state of being adjacent to each other in the column direction.

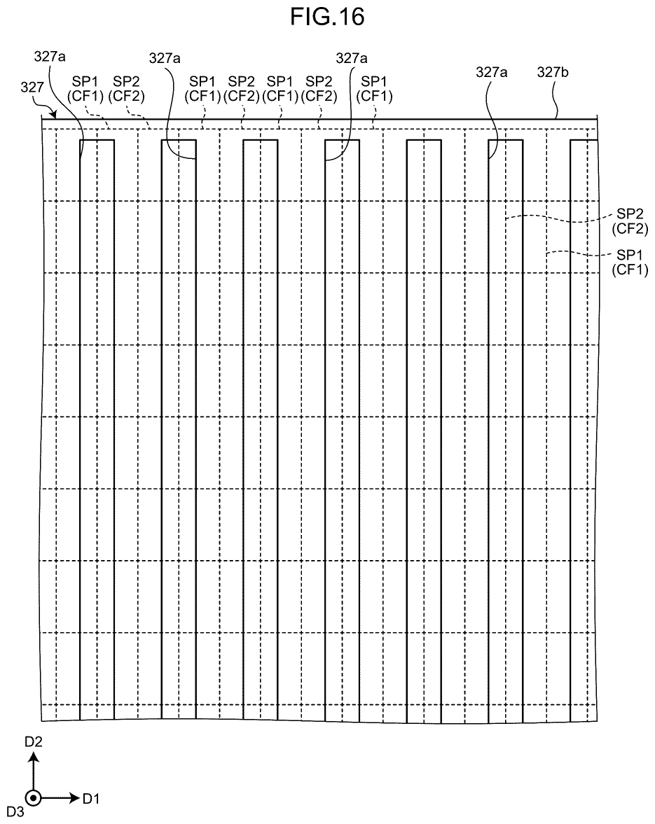

FIG. 16 is a plan view of a parallax barrier 327 of the liquid crystal panel 20 included in the display device 1 according to the third modification of the embodiment of the present disclosure. The parallax barrier 327 of the present modification corresponds to the arrangement of the first sub pixels SP1 and the second sub pixels SP2 illustrated in FIG. 15. The parallax barrier 327 includes openings 327a and a light-shielding part 327b.

In FIG. 16, the first sub pixels SP1 and the second sub pixels SP2 are illustrated with dashed lines. In the present modification, each opening 327a overlaps one first color filter CF1 and one second color filter CF2 adjacent to each other in the row direction in plan view. In the plan view illustrated in FIG. 16, as in the above-described embodiment, each opening 327a overlaps the negative D1 side of a first color filter CF1 and the positive D1 side of a second color filter CF2.

Each opening 327a has a shape extending in the column direction (second panel direction D2). Each opening 327a overlaps a plurality of first sub pixels SP1 arranged in the column direction and a plurality of second sub pixels SP2 arranged in the column direction in plan view. The openings 327a are disposed in the row direction (first panel direction D1).

Since the first sub pixels SP1, the second sub pixels SP2, and the openings 327a are disposed as illustrated in FIGS. 15 and 16, the viewing angle of the first image G1 and the viewing angle of the second image G2 are different from each other as in the above-described embodiment. In the present modification as well, the first sub pixels SP1 and the second sub pixels SP2 are disposed across the entire display region DA. Accordingly, the first image G1 and the second image G2 are simultaneously displayed in the entire display region DA.

In the parallax barrier 27 illustrated in FIG. 16, each opening 327a may be formed so as to overlap one first sub pixel SP1 and one second sub pixel SP2 in the column direction in plan view. In this case, the openings 327a are disposed in each of the row direction (first panel direction D1) and the column direction (second panel direction D2).

In the display device 1 according to the above-described embodiment and the display device 1 according to each modification, the first angle θ1 and the second angle θ2 illustrated in FIG. 10 may be set equal. In this case, the polarization direction of the third emission light SL3 is the same as the first polarization direction of the first linearly polarized light PL1.

The reflective plate 32 may be a mirror having a mirrored surface that reflects light transmitted through the quarter-wave plate 31, instead of a retroreflective plate. In this case, the optical element 30 is disposed in a state in which the mirrored surface is orthogonal to the second direction W2.

It should be understood that the present disclosure provides any other effects achieved by aspects described above in the present embodiment, such as effects that are clear from the description of the present specification or effects that could be thought of by the skilled person in the art as appropriate.

What is claimed is:

1. A display device comprising:
a light source device configured to emit first emission light in a first direction, the first emission light including first linearly polarized light and second linearly polarized light having a polarization direction orthogonal to the polarization direction of the first linearly polarized light;
a liquid crystal panel including a reflective polarizing plate having a plate surface on which the first emission light is incident, the reflective polarizing plate being configured to transmit the first linearly polarized light and reflect the second linearly polarized light in a second direction different from the first direction at the plate surface, the liquid crystal panel being configured to modulate the first linearly polarized light transmitted through the reflective polarizing plate and to emit the modulated first linearly polarized light toward a light-transmitting body in the first direction as second emission light corresponding to a first image; and
an optical element on which the second linearly polarized light reflected at the plate surface is incident along the second direction, the optical element being configured to impart a phase difference to the incident second linearly polarized light and to emit the second linearly polarized light in the second direction toward the plate surface as third emission light, wherein
the liquid crystal panel is configured to modulate the third emission light transmitted through the reflective polarizing plate and display a second image on a display surface, and
the optical element includes
a quarter-wave plate on which the second linearly polarized light reflected at the plate surface is incident along the second direction, and
a reflective plate configured to reflect light transmitted through the quarter-wave plate, in the second direction toward the quarter-wave plate.

2. The display device according to claim 1, wherein the light source device includes
a plurality of light emitters, and
a lens configured to refract light emitted from the light emitters in the first direction and to emit the light as the first emission light.

3. The display device according to claim 1, wherein the reflective plate is a retroreflective plate.

4. The display device according to claim 1, wherein a tilt angle between an orthogonal direction orthogonal to the plate surface and the first direction is 30°±5°.

5. The display device according to claim 1, wherein
the quarter-wave plate has a fast axis and a slow axis orthogonal to each other, and
in plan view of the quarter-wave plate, a first angle between the polarization direction of the second linearly polarized light and the fast axis and a second angle between the polarization direction of the second linearly polarized light and the slow axis are different from each other.

6. The display device according to claim 1, further comprising a diffusion sheet disposed between the light source device and the plate surface and between the optical element and the plate surface.

7. The display device according to claim 1, wherein the liquid crystal panel
includes a plurality of first sub pixels corresponding to the first image and a plurality of second sub pixels corresponding to the second image, the first and second sub pixels being disposed in a matrix of rows and columns in plan view, and
further includes a parallax barrier configured to
pass the first linearly polarized light transmitted through the first sub pixels and the third emission light transmitted through the second sub pixels and
block the third emission light transmitted through the first sub pixels and the first linearly polarized light transmitted through the second sub pixels.
